(19) United States
(12) Patent Application Publication
(10) Pub. No.: US 2019/0050379 A1
(43) Pub. Date: Feb. 14, 2019

(54) METHOD FOR PROVIDING DATA MANAGEMENT SERVICE HAVING AUTOMATIC CELL MERGING FUNCTION AND SERVICE PROVIDING SERVER FOR PERFORMING THE METHOD

(71) Applicant: EMRO CO., LTD., Seoul (KR)

(72) Inventor: Young Joon JEON, Seoul (KR)

(21) Appl. No.: 15/692,705

(22) Filed: Aug. 31, 2017

(30) Foreign Application Priority Data
Aug. 11, 2017 (KR) 10-2017-0102203

(51) Int. Cl. G06F 17/24

(52) U.S. Cl. CPC G06F 17/243; G06F 17/246

(57) ABSTRACT

A method of providing a data management service having an automatic cell merging function from a service providing server includes: (a) receiving a data table in which a plurality of columns are listed through an operation page provided to a user terminal; (b) determining whether a cell value of a first row of a predetermined column and a cell value of a second row of the predetermined column coincide with each other on the basis of the received data table, and when it is determined that the cell values of the first and second rows coincide with each other, performing an automatic cell merging operation to merge the cells of the first and second rows; and (c) processing the automatic cell merging completed data table to be displayed on the operation page by providing the data table to the user terminal.

### CROSS-REFERENCE TO RELATED APPLICATION

This application claims priority to and the benefit of Korean Patent Application No. 2017-0102203, filed on Aug. 11, 2017, the disclosure of which is incorporated herein by reference in its entirety.

### BACKGROUND

### 1. Field of the Invention

The present invention relates to a method of providing a data management service having an automatic cell merging function and a service providing server for performing the method, and more specifically, to a method of providing a data management service having an automatic cell merging function which performs automatic merging on neighboring cells determined to have the same values among a plurality of cells in the same column and processes an automatic cell merging completed data table to be displayed on an operation page, and a service providing server for performing the method.

### 2. Discussion of Related Art

As computer use becomes more widespread, the amount of data to be processed is increasing exponentially.

In order to manage a large amount of data, a worksheet program, such as Excel, is used, which has difficulties in managing a data set consisting of a plurality of columns and rows.

When the data set is organized and managed in order to facilitate data readability for analyzing or interpreting the data set consisting of a plurality of columns and rows, it takes a long period of time for the user to manually perform a cell merging operation on cells having the same values in each of the columns, and thus productivity of a cell merging operation and data analysis is lowered.

Therefore, there is an increasing demand for improving user convenience and productivity in data analysis by automatically processing a cell merging operation for a data set consisting of a plurality of columns and rows on a server and providing the resulting data set to the user. In addition, there is an urgent need for a solution to solve the aforementioned problems.

### SUMMARY OF THE INVENTION

The present invention is made to solve the above-described problems of the related art, and one objective of the present invention is to provide a method of providing a data management service having an automatic cell merging function which performs automatic merging on neighboring cells determined to have the same values among a plurality of cells in the same column and processes an automatic cell merging completed data table to be displayed on an operation page, and a service providing server for performing the method.

However, the objective of the present invention is not limited to the above description and various other objectives can be clearly understood by those skilled in the art from the following description.

In one general aspect, there is provided a method of providing a data management service having an automatic cell merging function from a service providing server, the method including: (a) receiving a data table in which a plurality of columns are listed through an operation page provided to a user terminal; (b) determining whether a cell value of a first row of a predetermined column and a cell value of a second row of the predetermined column coincide with each other on the basis of the received data table, and when it is determined that the cell values of the first and second rows coincide with each other, performing an automatic cell merging operation to merge the cells of the first and second rows; and (c) when the automatic cell merging operation on the predetermined column is completed, processing the automatic cell merging completed data table to be displayed on the operation page by providing the data table to the user terminal.

The predetermined column may include one or more columns specified by a user.

When a plurality of predetermined columns are present, the determining may include performing the automatic cell merging operation on each of the plurality of columns.

The determining may include, when it is determined that the cell value of the first row does not coincide with the cell value of the second row, determining whether the cell value of the second row coincides with a cell value of the third row, without merging the cells of the first and second rows.

The determining may include, after automatically merging the cells of the first and second rows, determining whether a value of a first merged cell into which the cells of the first and second rows are merged coincides with a cell value of the third row.

The determining may include, when a first group column which groups a first column and a second column as sub-columns among the plurality of columns listed in the data table is present, performing the automatic cell merging operation on the first column and the second column, which are sub-columns under the first group column.

In another general aspect, there is provided a service providing server including: a data table receiver configured to receive a data table in which a plurality of columns are listed through an operation page provided to a user terminal; an automatic cell merging unit configured to determine whether a cell value of a first row of a predetermined column and a cell value of a second row of the predetermined column coincide with each other on the basis of the received data table, and, when it is determined that the cell values of the first and second rows coincide with each other, perform an automatic cell merging operation to merge the cells of the first and second rows; and a display processor configured to process the automatic cell merging completed data table to be displayed on the operation page by providing the data table to the user terminal when the automatic cell merging operation on the predetermined column is completed.

The predetermined column may include one or more columns specified by a user.

When a plurality of predetermined columns are present, the automatic cell merging unit may perform the automatic cell merging operation on each of the plurality of columns.

When it is determined that the cell value of the first row does not coincide with the cell value of the second row, the automatic cell merging unit may determine whether the cell value of the second row coincides with a cell value of the third row, without merging the cells of the first and second rows.

The automatic cell merging unit may determine whether a value of a first merged cell into which the cells of the first and second rows are merged coincides with a cell value of the third row, after automatically merging the cells of the first and second rows.

When a first group column which groups a first column and a second column as sub-columns among the plurality of columns listed in the data table is present, the automatic cell merging unit may perform the automatic cell merging operation on the first column and the second column, which are sub-columns under the first group column.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram schematically illustrating a configuration of a data management service providing system having an automatic cell merging function according to one embodiment of the present invention;

FIG. 2 is a block diagram illustrating a configuration of a service providing server according to one embodiment of the present invention;

FIG. 3 is a diagram illustrating an operation page on which a table in which automatic cell merging for a specific column is performed is displayed according to one embodiment of the present invention; and

FIG. 4 is a diagram illustrating an operation page on which a table having automatically merged cells is displayed for a case where predetermined columns are grouped according to one embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. The present invention may, however, be embodied in many different forms and should not be construed as being limited to the embodiments set forth herein. Also, irrelevant details have been omitted from the drawings for increased clarity and conciseness, and similar parts are indicated by similar reference numerals throughout the detailed description.

Throughout the specification, it will be understood that when an element is referred to as being “connected to” another element, it can be directly connected to the other element, or intervening elements may be present. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

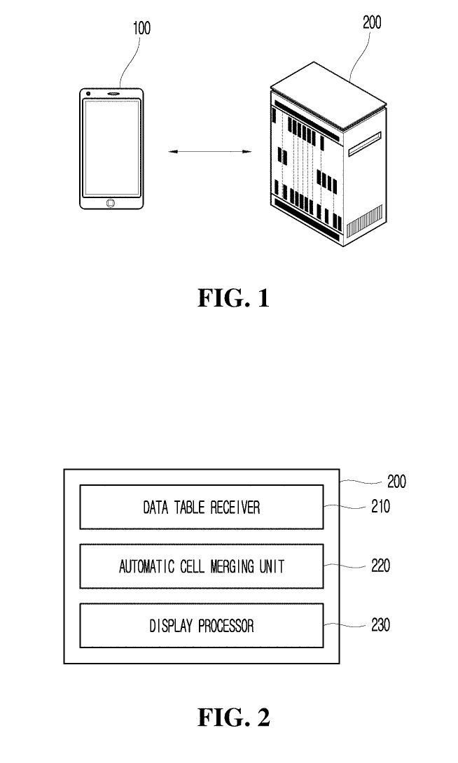

FIG. 1 is a diagram schematically illustrating a configuration of a data management service providing system having an automatic cell merging function according to one embodiment of the present invention.

Referring to FIG. 1, the data management service providing system having an automatic cell merging function according to one embodiment of the present invention includes a user terminal 100 and a service providing server 200.

The user terminal 100 and the service providing server 200 may be mutually connected to each other via a communication network. In this case, the communication network may be configured without regard to its communication mode, such as wired and wireless, and may be configured as various communication networks, such as a local area network (LAN), a metropolitan area network (MAN), a wide area network (WAN), and the like.

The user terminal 100 may include any type of handheld based wireless communication device having a touch screen panel, such as a mobile phone, a smartphone, a personal digital assistant (PDA), a portable multimedia player (PMP), or a tablet PC. In addition, the user terminal 100 may include any devices on which an application can be installed and run, such as a desktop PC, a tablet PC, a laptop PC, and an IPTV including a set-top box.

The user terminal 100 may access the service providing server 200 through an application, a web browser, or the like, and be provided with a data management service. In this case, the service providing server 200 may provide the data management service to the user terminal by providing an operation page for data editing.

The user terminal 100 may display the operation page provided by the service providing server 200 on a screen and further display a data set formed as a table on the operation page. In this case, the data set may be manually input by a user or obtained from a previously stored file, and may be displayed in a data area provided on a portion of the operation page.

The user terminal 100 may provide the service providing server 200 with the data table, which is a data set configured in a table.

When the user terminal 100 receives a data table in which automatic cell merging for a specific column is completed from the service providing server 200, the user terminal 100 may display the received data table on the operation page.

When the service providing server 200 receives a data table in which a plurality of columns are listed from the user terminal 100 through the operation page, the service providing server 200 may determine whether a cell value of the first row of the specific column coincides with a cell value of the second row on the basis of the received data table, and it may or may not merge the first and second cells according to the determination. In this case, the specific column may be one or more columns specified by a user.

According to one embodiment, after automatically merging the first and second cells, the service providing server 200 may or may not perform additional merging by determining whether a value of a first merged cell in which the cells of first and second rows are merged matches a cell value of the third row.

In addition, according to one embodiment, when it is determined that the cell value of the first row does not coincide with the cell value of the second row, the service providing server 200 may or may not perform merging of the cell of the second row and the cell of the third row by determining whether the cell value of the second row matches a cell value of the third row.

When the automatic cell merging for the specific cell is completed, the service providing server 200 may process a data table to be displayed on the operation page by providing the user terminal 100 with the data table in which the automatic cell merging is completed.

FIG. 2 is a block diagram illustrating a configuration of a service providing server 200 according to one embodiment of the present invention.

Referring to FIG. 2, the service providing server 200 according to one embodiment of the present invention includes a data table receiver 210, an automatic cell merging unit 220, and a display processor 230.

Hereinafter, the configuration of the service providing server 200 will be described in detail with reference to one embodiment of automatic cell merging for a specific column.

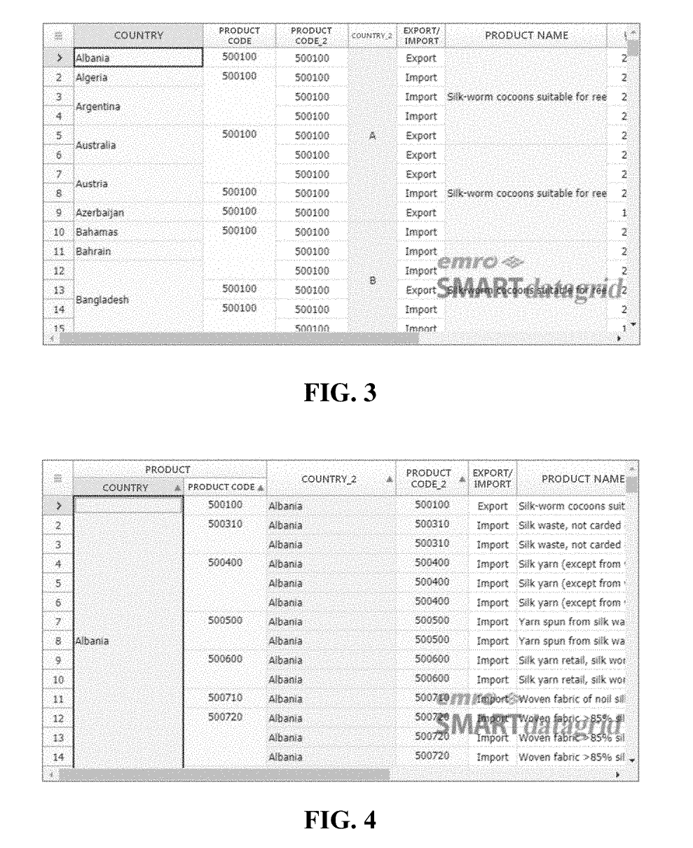

First, the service providing server 200 may provide an operation page for data editing to the user terminal 100, and through the operation page, the user terminal 100 may receive a data table in which a plurality of cells consisting of a plurality of columns and rows and cell values, that is, data values are listed. The operation page will be described in detail with reference to FIG. 3.

FIG. 3 is a diagram illustrating an operation page on which a table in which automatic cell merging for a specific column is performed is displayed according to one embodiment of the present invention.

As shown in FIG. 3, a part of the operation page is composed of headers of columns, and another part of the operation page includes a data table composed of a list of data values corresponding to the respective columns. The data table may be transmitted to the service providing server 200 through the operation page displayed on the user terminal 100.

Accordingly, the data table receiver 210 may receive the data table listing a plurality of columns from the user terminal 100 through the operation page.

The automatic cell merging unit 220 may determine whether a cell value of the first row coincides with a value of the second row's cell neighboring the cell of the first row with respect to a specific column on the basis of the received data table, and when it is determined that the cell value of the first row coincides with the cell value of the second row, the automatic cell merging unit 220 may perform an automatic cell merging operation to merge the cells of the first and second rows.

For example, with respect to the neighboring third and fourth rows of the “Country” column shown in FIG. 3, the automatic cell merging unit 220 determines that a cell value of the third row of the “Country” column, which is “Argentina,” coincides with a cell value of the fourth row and may merge the cells of the third and fourth rows into one cell having a cell value of “Argentina”.

The described-above specific column for which automatic cell merging is performed may be one or more columns specified by the user, and when the user specifies a plurality of columns, the automatic cell merging unit 220 may perform an automatic cell merging operation on each of the plurality of columns. For example, when the specific columns specified by the user are the “Country” column, “Product Code” column, “Country_2” column, and “Product Name” column, the automatic cell merging unit 220 may perform an automatic cell merging operation on the “Country” column, and then perform an automatic cell merging operation sequentially on the “Product Code” column, “Country_2” column, and “Product Name” column, or may perform an automatic cell merging operation simultaneously on the “Country” column, “Product Code” column, “Country_2” column, and “Product Name” column.

According to one embodiment of the present invention, the automatic cell merging unit 220 may determine whether values of the neighboring cells of the first and second rows of a specific column coincide with each other. When it is determined that the cell values of the first and second rows do not coincide with each other, the automatic cell merging unit 220 may determine whether values of the next neighboring cells of the second and third rows coincide with each other, without merging the cells of the first and second rows, and may or may not merge the cells of the second and third rows.

For example, with respect to the neighboring first and second rows of the “Country” column shown in FIG. 3, the automatic cell merging unit 220 may determine that “Albania” which is a cell value of the first row of the “Country” column does not coincide with “Algeria” which is a cell value of the second row, and may not merge the cells of the first row and the second row of “Country” column. Thereafter, the automatic cell merging unit 220 may determine whether “Algeria” which is the cell value of the second row of the “Country” column coincides with “Argentina” which is a cell value of the third row, and may or may not merge the cells of the second and third rows.

After merging the cells of the first and second rows, the automatic cell merging unit 220 determines whether a cell value of a first merged cell into which the cells of the first and second rows are merged coincides with the cell value of the third row which adjoins the first merged cell, and when it is determined that the cell value of the first merged row coincides with the cell value of the third row, the automatic cell merging unit 220 may perform an automatic cell merging operation to merge the first merged cell with the cell of the third row. Accordingly, a second merged cell into which the first merged cell and a cell of the third row are merged may be generated.

For example, with respect to the twelfth to fifteenth rows of “Country” column shown in FIG. 3, the automatic cell merging unit 220 determines that a cell value of the twelfth row coincides with a cell value of the thirteenth row's cell neighboring the cell of the twelfth row, which is “Bangladesh,” and may merge the cells of the twelfth and thirteenth rows into a first merged cell. Thereafter, the automatic cell merging unit 220 may determine whether a value of the first merged cell coincides with a value of the fourteenth row's cell neighboring the first merged cell. As shown in FIG. 3, when the automatic cell merging unit 220 determines that the value of the first merged cell into which the cells of the twelfth and thirteenth rows are merged coincides with the cell value of the fourteenth row, the automatic cell merging unit 220 may automatically merge the first merged cell and the cell of the fourteenth row into a second merged cell. Consecutively, the automatic cell merging unit 220 may determine whether the value of the second merged cell coincides with a value of the fifteenth row's cell neighboring the second merged cell.

According to one embodiment, the automatic cell merging unit 220 may determine whether the cell value of the first merged cell coincides with the cell value of the third row's cell neighboring the first merged cell. When it is determined that the cell value of the first merged cell does not coincide with the cell value of the third row, the automatic cell merging unit 220 does not merge the first merged cell and the cell of the third row, but may determine whether the cell value of the third row coincides with the cell value of the fourth row which adjoins the cell of the third row, and may or may not perform an automatic cell merging operation to merge the cells of the third and fourth rows.

For example, with respect to the seventh to ninth rows of the “Country” column shown in FIG. 3, the automatic cell merging unit 220 may determine that a cell value of the seventh row coincides with a value of the eighth row's cell neighboring the cell of the seventh row, which is “Austria,” and merge the cells of the seventh and eighth rows into a first merged cell. Then, the automatic cell merging unit 220 may determine whether a value of the first merged cell coincides with a value of the ninth row's cell neighboring the first merged cell. As shown in FIG. 3, the automatic cell merging unit 220 determines that “Austria” which is the value of the first merged cell into which the cells of the seventh and eight rows are merged does not coincide with “Azerbaijan” which is the cell value of the ninth row, and may not automatically merge the first merged cell and the cell of the ninth row. Subsequently, the automatic cell merging unit 220 may determine whether the cell value of the ninth row coincides with a value of the tenth row's cell neighboring the cell of the ninth row.

According to one embodiment of the present invention, the automatic cell merging unit 220 may perform an automatic cell merging operation according to a condition preset by the user, regardless of whether it is performed to determine whether cell values of a specific column coincide with each other and the determination result.

For example, when the user sets a condition that automatic cell merging is performed on cells corresponding to every five rows of the “Product Name” column, the automatic cell merging unit 220 may perform a conditional automatic cell merging operation in which cells corresponding to every five rows in the “Product Name” column are merged into one cell and one cell value, as shown in FIG. 3.

When the automatic cell merging operation on the specific column is completed according to the above embodiment, the display processor 230 may process an automatic cell merging completed data table to be displayed on the operation page by providing the data table to the user terminal 100.

According to one embodiment of the present invention, when a specific group column is included in the data table received from the user terminal 100 through the operation page, the service providing server 200 may perform an automatic cell merging operation on a plurality of sub-columns under the group column. The automatic cell merging operation for this case will be described in detail with reference to FIG. 4.

FIG. 4 is a diagram illustrating an operation page on which a table with automatically merged cells is displayed for a case where predetermined columns are grouped according to one embodiment of the present invention.

As shown in FIG. 4, when there is a first group column into which a first column and a second column are grouped as sub-columns among a plurality of columns listed in the data table received from the user terminal 100 through the operation page, the automatic cell merging unit 220 may perform an automatic cell merging operation only on the first column and the second column, which are sub-columns of the first group column. Accordingly, an automatic cell merging operation may not be performed on one or more columns excluding the first group column.

For example, in the case of a data table including the “Country” column, “Product Code” column, “Country_2” column, “Product Code_2” column, “Export/Import” column, and “Product Name” column, if the “Product” column which groups the “Country” column and “Product Code” column as sub-columns is present, the automatic cell merging unit 220 may perform an automatic cell merging operation on the “Product” group, that is, the “Country” column and “Product Code” column even when the user does not specify one or more specific columns. Meanwhile, the automatic cell merging operation may not be performed on the ungrouped columns, the “Country_2” column, “Product Code_2” column, “Export/Import” column, and “Product Name” column.

When the automatic cell merging operation on the group column in the data table having predetermined groups grouped as described above is completed, the display processor 230 may process the automatic cell merging completed data table to be displayed on the operation page by providing the data table to the user terminal 100.

As described above, according to one embodiment of the present invention, cell merging of a specific column for a data table is automatically performed within a service providing server and then displayed on an operation page, so that the user does not need to manually perform cell merging for each column and thus it is possible to increase convenience in data management for a user.

However, the effects of the present invention are not limited to the effects described above, and other effects that have not been set forth herein will be clearly understood from the detailed description of the present invention or the appended claims by those skilled in the art.

The foregoing description of the invention is for illustrative purposes and a person having ordinary skilled in the art will appreciate that other specific modifications can be easily made without departing from the technical spirit or essential features of the invention. Therefore, the foregoing embodiments should be regarded as illustrative rather than limiting in all aspects. For example, some components, each of which has been described as being a single form, can be embodied in the distributed form, whereas some components, which have been described as being distributed, can be embodied in the combined form.

The scope of the present invention is not defined by the detailed description as set forth above but by the accompanying claims of the invention. It should also be understood that all changes or modifications derived from the definitions and scopes of the claims and their equivalents fall within the scope of the invention.

What is claimed is:

1. A method of providing a data management service having an automatic cell merging function from a service providing server, the method comprising:
(a) receiving a data table in which a plurality of columns are listed through an operation page provided to a user terminal;
(b) determining whether a cell value of a first row of a predetermined column and a cell value of a second row of the predetermined column coincide with each other on the basis of the received data table, and when it is determined that the cell values of the first and second rows coincide with each other, performing an automatic cell merging operation to merge the cells of the first and second rows; and
(c) when the automatic cell merging operation on the predetermined column is completed, processing the automatic cell merging completed data table to be displayed on the operation page by providing the data table to the user terminal.

2. The method of claim 1, wherein the predetermined column includes one or more columns specified by a user.

3. The method of claim 1, wherein, when a plurality of predetermined columns are present, the determining includes performing the automatic cell merging operation on each of the plurality of columns.

4. The method of claim 1, wherein the determining includes, when it is determined that the cell value of the first row does not coincide with the cell value of the second row, determining whether the cell value of the second row coincides with a cell value of the third row, without merging the cells of the first and second rows.

5. The method of claim 1, wherein the determining includes, after automatically merging the cells of the first and second rows, determining whether a value of a first merged cell into which the cells of the first and second rows are merged coincides with a cell value of the third row.

6. The method of claim 1, wherein the determining includes, when a first group column which groups a first column and a second column as sub-columns among the plurality of columns listed in the data table is present, performing the automatic cell merging operation on the first column and the second column, which are sub-columns under the first group column.

7. A service providing server comprising:
a data table receiver configured to receive a data table in which a plurality of columns are listed through an operation page provided to a user terminal;
an automatic cell merging unit configured to determine whether a cell value of a first row of a predetermined column and a cell value of a second row of the predetermined column coincide with each other on the basis of the received data table, and, when it is determined that the cell values of the first and second rows coincide with each other, perform an automatic cell merging operation to merge the cells of the first and second rows; and
a display processor configured to process the automatic cell merging completed data table to be displayed on the operation page by providing the data table to the user terminal when the automatic cell merging operation on the predetermined column is completed.

8. The service providing server of claim 7, wherein the predetermined column includes one or more columns specified by a user.

9. The service providing server of claim 7, wherein when a plurality of predetermined columns are present, the automatic cell merging unit performs the automatic cell merging operation on each of the plurality of columns.

10. The service providing server of claim 7, wherein, when it is determined that the cell value of the first row does not coincide with the cell value of the second row, the automatic cell merging unit determines whether the cell value of the second row coincides with a cell value of the third row, without merging the cells of the first and second rows.

11. The service providing server of claim 7, wherein the automatic cell merging unit determines whether a value of a first merged cell into which the cells of the first and second rows are merged coincides with a cell value of the third row, after automatically merging the cells of the first and second rows.

12. The service providing server of claim 7, wherein, when a first group column which groups a first column and a second column as sub-columns among the plurality of columns listed in the data table is present, the automatic cell merging unit performs the automatic cell merging operation on the first column and the second column, which are sub-columns under the first group column.
